(19) United States
(12) Patent Application Publication
(10) Pub. No.: US 2014/0305675 A1
(43) Pub. Date: Oct. 16, 2014

(54) USB CABLE

(71) Applicant: HON HAI PRECISION INDUSTRY CO., LTD., New Taipei (TW)

(72) Inventors: XIN-GUANG LIANG, Xipu (CN); SHANG-HUA ZHAO, Renhe (CN); LU-YU CHANG, New Taipei (TW)

(73) Assignee: HON HAI PRECISION INDUSTRY CO., LTD., New Taipei (TW)

(21) Appl. No.: 14/250,395

(22) Filed: Apr. 11, 2014

(30) Foreign Application Priority Data
Apr. 11, 2013 (CN) 2013201799309

(51) Int. Cl. H01B 9/00

(52) U.S. Cl. CPC H01B 9/003
USPC 174/107

(57) ABSTRACT

A USB cable (100), comprising: a power wire (1) transferring positive power, a pair of signal wires (2), a metallic braided layer (6) enclosing on the power wire and the signal wires, and an insulative outer jacket (7) surrounding the metallic braided layer. The power wire comprises a metallic inner conductor and an insulative layer surrounding the inner conductor, a mylar film (11) is surrounding on the power wire, and the mylar film is made of Heat Seal PET.

### FIELD OF THE INVENTION

The present invention relates to a cable, and more particularly to a USB (universal serial bus) cable.

### DESCRIPTION OF PRIOR ART

Universal Serial Bus, or “USB” is a commonly used term that refers to a standard for connecting two electronic devices or for connecting a device and a host computer. Using USB technology, a plurality of peripherals can be connected using a single standardized interface socket. As of 2006, the USB specification was at version 2.0 (with revisions). The USB 2.0 specification was released in April 2000 and was standardized by the USB-IF at the end of 2001.

According to USB 2.0 specification, a USB cable has four inner wires, including a pair of signal wires transferring D−, D+ signal, the other two wires being power wires. The USB cable is used widely with a function of charging. The power wire of USB cable is required to transfer larger electric current used for peripheral equipments demanding high power, thus the inner wires may have larger external dimensions, though characteristics of small dimension and flexibility of USB cables are determined by specific needs. For meeting a smaller overall dimension while a larger current-carrying conductor, the wire might have a thinner insulating layer, raising concern for safety issue. U.S. Patent Application Publication No. 2012/0227996, to Ardisana, II et al. on Sep. 13, 2012, discloses a cable that can be used as a USB cable, including a conductor bundle, an EMI shield, a braided shield, and a jacket, the conductor bundle can form the core of cable and include one or more conductors for conveying signals and/or power, depending on the desired function of cable.

An improved USB cable is desired.

### SUMMARY OF THE INVENTION

Accordingly, an object of the present invention is to provide a USB cable with a smaller overall dimension for power and signal transmission.

In order to achieve the above-mentioned objects, a USB cable comprises a power wire transferring positive power, a pair of signal wires, a metallic braided layer enclosing on the power wire and the signal wires, and an insulative outer jacket surrounding the metallic braided layer. The power wire comprises a metallic inner conductor and an insulative layer surrounding the inner conductor, a mylar film is surrounding on the power wire, and the mylar film is made of Heat Seal PET.

Other objects, features and advantages of the invention will be apparent from the following detailed description taken in connection with the accompanying drawings.

### BRIEF DESCRIPTION OF THE DRAWINGS

FIG. 1 is a cross-section view of a USB cable in accordance with the present invention.

### DETAILED DESCRIPTION OF PREFERRED EMBODIMENTS

Reference will now be made to the drawing figures to describe the present invention in detail.

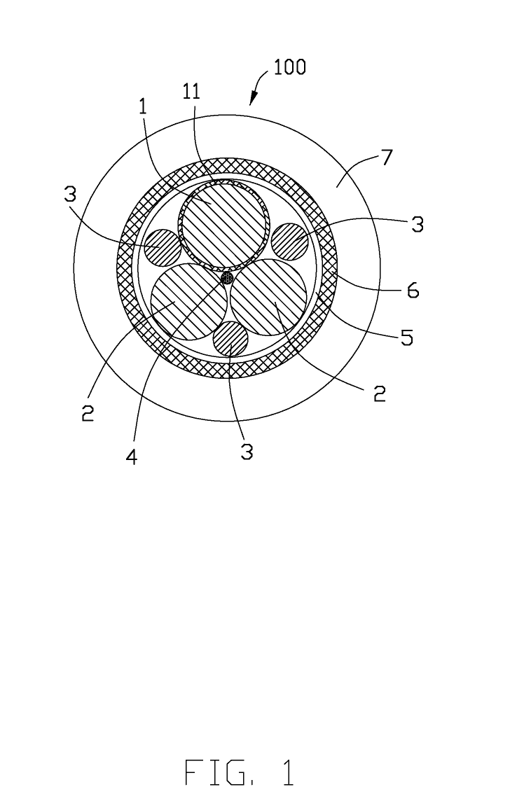

Referring to FIGS. 1, a cable 100 in accordance with the present invention is a USB (universal serial bus) cable, and comprises a power wire 1 transmitting positive electricity and a pair of signal wires 2 for differential signal transmission. The power wire 1 and the signal wires 2 are extending along an axial direction of the cable 100, and formed a triangle shape in a cross section view of the cable 100 roughly.

The power wire 1 is used for transferring +5v power, the power wire 1 comprises a metallic inner conductor and an insulative layer surrounding the inner conductor, and each signal wire 2 has the same configuration as the power wire 1. The inner conductor is made of copper, and also can be made of aluminum or other selectiveable material. In preferred embodiment, the insulative layer of each of power and signal wires 1, 2 is made of FEP (Fluorinated Ethylene Propylene). The power wire 1 has an external diameter of 25 AWG (American Wire Gauge), and each signal wire 2 has an external diameter of 31 AWG, thus the power wire 1 has a larger dimension than the signal wire 2. A mylar film 11 is enclosing on the power wire 1 to prevent the USB cable being scratched in manufacturing and using, the mylar film 11 is made of Heat Seal PET (Polyethylene Terephthalate). In other embodiments, the mylar film 11 also can be metallic, such as aluminium foil. That is to say, the mylar film 11 covering on the power wire 1 can be metallic or nonmetallic, thus the insulative layer of the power wire 1 can be defined with thinner dimension but without risk of being scratched, thus it's safe in using and the whole dimension of the cable 100 can be decreased.

The cable 100 also comprises a plurality of drain wires 3, a strengthen member 4, a mylar layer 5, a metallic braided layer 6 enclosing on the mylar layer 5, and an insulative outer jacket 7 enclosing on the metallic braided layer 6. In preferred embodiment, the cable 100 includes three drain wires 3, and each drain wire 3 has an external diameter of 32 AWG The three drain wires 3 are mixed up with the power and signal wires 1, 2, and each drain wire 3 is neighboring to two of the power and signal wires 1, 2, the drain wires 3 are arranged with an isosceles triangle in a cross-section view. The metallic braided layer 6 and the drain wires 3 are in a parallel connection relationship for transmitting negative electricity, thus to replace a thick power wire of a conventional USB cable, therefore the number of internal wires of the USB cable can be decreased and the dimension of the whole USB cable is decreased simultaneously.

The strengthen member 4 is located in an axis of the cable 100. The mylar layer 5 is enclosing on the power wire 1, the signal wires 2 and the drain wires 3, and coaxial with the metallic braided layer 6. The metallic braided layer 6 can be of a single layer structure, and also can be of a double layer structure. The external dimension of the cable 100 is less than 3.1 millimeter.

It will be understood that the invention may be embodied in other specific forms without departing from the spirit or central characteristics thereof The present examples and embodiments, therefore, are to be considered in all respects as illustrative and not restrictive, and the invention is not to be limited to the details given herein.

What is claimed is:

1. A USB cable, comprising:
a power wire transferring positive power,
a pair of signal wires;
a metallic braided layer enclosing on the power wire and the signal wires; and
an insulative outer jacket surrounding the metallic braided layer; wherein
the power wire comprises a metallic inner conductor and an insulative layer surrounding the inner conductor, a mylar film is surrounding on the power wire, and the mylar film is made of Heat Seal PET.

2. The USB cable as recited in claim 1, further comprising a plurality of drain wires mixed up with the power and signal wires, and each drain wire is neighboring to two of the power and signal wires.

3. The USB cable as recited in claim 2, wherein the drain wires are arranged with an isosceles triangle in a cross-section view.

4. The USB cable as recited in claim 2, wherein the metallic braided layer and the drain wires are in a parallel connection relationship for transmitting negative electricity.

5. The USB cable as recited in claim 2, wherein the power wire and the signal wires are extending along an axial direction of the USB cable, and formed a triangle shape in cross section view of the USB cable.

6. The USB cable as recited in claim 5, wherein the power wire has a larger dimension than the signal wire.

7. The USB cable as recited in claim 6, wherein the power wire is transmitting +5V positive electricity and the pair of signal wires is used for differential signal transmission.

8. The USB cable as recited in claim 6, wherein an external dimension of the cable is less than 3.1 millimeter.

9. The USB cable as recited in claim 6, wherein the power wire has an external diameter of 25 AWG, and each signal wire has an external diameter of 31 AWG.

10. The USB cable as recited in claim 2, further comprising a strengthen member located in an axis of the cable.

11. The USB cable as recited in claim 1, wherein each drain wire has an external diameter of 32 AWG.

12. The USB cable as recited in claim 11, wherein a mylar layer is arranged on the power wire and the signal wires, and enclosed by the metallic braided layer.

13. The USB cable as recited in claim 1, wherein the mylar film can be metallic or nonmetallic.

14. An electrical cable comprising:
a power wire transferring positive power,
a pair of signal wires intimately contacting the power wire laterally;
three drain wires intermixed with said power wire and said pair of signal wires in an alternate manner;
a metallic braided layer enclosing the power wire and the signal wires and the drain wires; and
an insulative outer jacket surrounding the metallic braided layer; wherein
the power wire comprises a metallic inner conductor and an insulative layer surrounding the inner conductor, a reinforcement film surrounds on the power wire; wherein
each of the signal wires is diametrically smaller than the power wire without the reinforcement film thereon.

15. The electrical cable as claimed in claim 14, further including an axially extending strengthening member at a center surrounded by the power wire, the in a cross-sectional view.

16. The electrical cable as claimed in claim 15, wherein said strengthening member intimately contacts the power wire and the signal wires while spaced and isolated from the drain wires by said power wire and said signal wires.

17. The electrical cable as claimed in claim 16, wherein a mylar layer is applied upon an interior surface of the braided layer.

18. The electrical cable as claimed in claim 14, wherein in a cross-sectional view the power wire and the pair of signal wires are arranged as an isosceles triangle, and the three draw wires are arranged as another isosceles triangle partially overlapped with the isosceles triangle in an upside-down manner.

19. The electrical cable as claimed in claim 14, wherein the reinforcement film is a mylar film.

20. The electrical cable as claimed in claim 19, wherein said mylar film is made of Heat Seal PET.
